(19) United States
(12) Patent Application Publication
(10) Pub. No.: US 2013/0233357 A1
(43) Pub. Date: Sep. 12, 2013

(54) METHOD FOR REMOVING PHOTORESIST

(71) Applicants: Takashi Minamihonoki, Osaka-shi (JP); Norikazu Hohshi, Osaka-shi (JP)

(72) Inventors: Takashi Minamihonoki, Osaka-shi (JP); Norikazu Hohshi, Osaka-shi (JP)

(73) Assignee: SHARP KABUSHIKI KAISHA, Osaka (JP)

(21) Appl. No.: 13/813,573

(22) PCT Filed: Sep. 13, 2011
(86) PCT No.: PCT/JP2011/070823

§ 371 Date: Mar. 7, 2013

(30) Foreign Application Priority Data
Nov. 30, 2010 (JP) 2010-267859

(51) Int. Cl. B08B 7/00

(52) U.S. Cl. CPC B08B 7/00
USPC 134/34

(57) ABSTRACT

The invention relates to a method for removing a photoresist capable of attaining a sufficient removal rate even using a general-purpose cleaning apparatus. A photoresist formed on a surface of a substrate is removed using supersaturated water solution of ozone. Further, it is preferred that a removal operation is performed under a condition of suppressing reduction in ozone concentration of the supersaturated water solution.

### TECHNICAL FIELD

The present invention relates to a method for removing a photoresist used in a manufacturing process of a semiconductor device, a liquid crystal display, or the like.

### BACKGROUND ART

In a manufacturing process of a semiconductor device, a liquid crystal display or the like, photolithography or etching is used as a method of processing a fine circuit pattern, for example. In both photolithography and etching, the surface of a processed material is masked with a resist film to form a circuit pattern. Fine processing is required for the mask itself of the resist film, and a photoresist made of an ultraviolet curing resin or the like is thus used for the resist film. A photoresist mask becomes unnecessary after the circuit pattern is formed, and is thus required to be removed.

For removal of a photoresist, acid liquid such as a mixture of sulfuric acid and hydrogen peroxide water, alkaline liquid such as sodium hydroxide, an organic solvent such as monoethanolamine (hereinafter, referred to as chemicals) or the like is used. However, recently, the use of these chemicals is reduced in consideration of global environment, and a cleaning method has been proposed using ozone water with a reduced environmental load. Ozone water is used for cleaning treatment, and thereafter ozone molecules dissolved in water are immediately broken down to oxygen molecules, thus reducing an environmental load.

However, ozone water cleaning is performed using a general cleaning machine that has been conventionally used at a slow removal rate of photoresist, and thus difficult to be put into practical use. A slow removal rate is mainly caused by reduction in ozone concentration in ozone water due to reduction of the pressure in ozone water to nearly atmospheric pressure when ozone water is supplied from an ozone water production apparatus to a cleaning tank. Therefore, in order to apply ozone water cleaning, both a dedicated cleaning machine and an ozone water production apparatus taking measures to prevent reduction in ozone concentration are necessary. Thus, switching from a conventional cleaning method using chemicals to ozone water cleaning requires a large economic burden, which causes prevention of popularization of ozone water cleaning.

A representative example of a combination of the ozone water production apparatus and the dedicated cleaning machine is described in Patent Literature 1. In the method of removing a photoresist film described in Patent Literature 1, a dedicated ozone water cleaning tank employing a structure for increasing a flow rate of ozone water on a silicon wafer surface and an ozone water production apparatus are combined to secure a resist removal rate required for practical application.

### CITATION LIST

### Patent Literature

Patent Literature 1: Japanese Unexamined Patent Publication JP-A 2002-33300

### SUMMARY OF INVENTION

### Technical Problem

In the case of attempting to remove a photoresist with ozone water as described above, it is required to use a cleaning apparatus having a specific structure for securing a sufficient removal rate, and it is thus impossible to obtain a sufficient removal rate using a general-purpose cleaning apparatus.

An object of the invention is to provide a method for removing a photoresist capable of attaining a sufficient removal rate even using a general-purpose cleaning apparatus.

### Solution to Problem

The invention provides a method for removing a photoresist including performing a removal operation of removing a photoresist formed on a surface of a substrate using supersaturated water solution of ozone.

Further, in the invention, it is preferable that the removal operation is performed under a condition of suppressing reduction in ozone concentration of the supersaturated water solution.

Further, in the invention, it is preferable that the removal operation is an operation for immersing the substrate on which a photoresist is formed in a dipping vat storing the supersaturated water solution, and the dipping vat is composed of an airtight container in which the substrate is immersed under a condition where a pressure in the airtight container is higher than atmospheric pressure.

Further, in the invention, it is preferable that the removal operation is an operation for discharging the supersaturated water solution from a nozzle to spray the supersaturated water solution to the photoresist formed on the surface of the substrate, and

the nozzle is brought close to the photoresist to perform spraying to the photoresist under a condition where a pressure applied on the supersaturated water solution is higher than atmospheric pressure.

### Advantageous Effects of Invention

According to the invention, a removal operation of removing a photoresist formed on a substrate surface is performed using supersaturated water solution of ozone,

Thereby, it is possible to attain a sufficient removal rate even using a general-purpose cleaning apparatus. Additionally, an economical burden associated with switching from a conventional cleaning method using chemicals to ozone water cleaning is reduced, so that it is possible to easily realize ozone water cleaning with a reduced environmental load.

According to the invention, it is possible to further increase a removal rate by performing the removal operation under a condition of suppressing reduction in ozone concentration of the supersaturated water solution.

According to the invention, the removal operation is an operation for immersing the substrate on which a photoresist is formed in a dipping vat storing the supersaturated water solution, and the dipping vat is composed of an airtight container in which the substrate is immersed under a condition where a pressure in the airtight container is higher than atmospheric pressure.

This makes it possible to improve a general-purpose batch treatment type device to suppress reduction in ozone concentration.

According to the invention, the removal operation is an operation for discharging the supersaturated water solution from a nozzle to spray the supersaturated water solution to the photoresist formed on the surface of the substrate, and the nozzle is brought close to the photoresist to perform spraying to the photoresist under a condition where a pressure applied on the supersaturated water solution is higher than atmospheric pressure.

This makes it possible to improve a general-purpose single wafer processing type device to suppress reduction in ozone concentration.

Other and further objects, features, and advantages of the invention will be more explicit from the following detailed description taken with reference to the drawings.

### BRIEF DESCRIPTION OF DRAWINGS

FIG. 1 is a schematic view showing a configuration of an ozone water production apparatus 1 for producing supersaturated ozone water;

FIG. 2A is a view showing an example of a general-purpose cleaning apparatus;

FIG. 2B is a view showing an example of a general-purpose cleaning apparatus;

FIG. 3A is a view showing an example of a cleaning apparatus including a function to suppress reduction in ozone concentration; and

FIG. 3B is a view showing an example of a cleaning apparatus including a function to suppress reduction in ozone concentration.

### DESCRIPTION OF EMBODIMENTS

Now referring to the drawings, preferred embodiments of the invention are described below.

The invention provides a method for removing a photoresist including performing a removal operation of removing a photoresist formed on a substrate surface using supersaturated water solution of ozone.

A substrate on which a photoresist is formed is a member masked with a photoresist such as a silicon wafer, a glass substrate or the like by means of photolithography, etching or the like, which is not particularly limited.

For materials used as a photoresist, a phenolic novolac resin is mainly used, and additionally, a (meth)acrylic acid ester, a norbornene derivative, a polymer induced therefrom, and the like are used.

Supersaturated water solution of ozone is water solution having dissolved ozone which becomes supersaturated, in which a high concentration of ozone is dissolved in an amount exceeding a saturation dissolution amount. Note that, hereinafter, water solution at ozone concentration in the saturation dissolution amount or less is referred to as normal ozone water, and water solution in a supersaturated state in an amount exceeding the saturation dissolution amount is referred to as supersaturated ozone water. The supersaturated ozone water should be completely distinguished from the normal ozone water in view of a theory of solution.

For example, judging from a producing condition described in Patent Literature 1, ozone water used in the invention described in Patent Literature 1 is the normal ozone water.

To summarize the producing method and the producing condition of ozone water shown in Patent Literature 1, the description will be given as follows. Solute ozone gas at the concentration of about 230 g/Nm³ is generated with an ozone gas generator, and thereafter the generated ozone gas is concentrated up to the concentration of about 800 g/Nm³ with a concentrator. On the other hand, for water as a solvent, ultrapure water heated to a temperature of 45 to 50° C. at the pressure of 0.1 to 0.2 MPa is used. The concentrated ozone gas is mixed with the heated pure water to produce heated ozone water at the concentration of about 50 mg/L (=ppm).

In the case of estimating saturation solubility of the heated ozone water shown in Patent Literature 1 from these conditions, the saturation solubility at 50° C. is 296 mg/L, and the concentration shown in Patent Literature 1 is about 50 mg/L, thus judging that the heated ozone water is the normal ozone water at concentrations sufficiently lower than the saturation solubility.

The saturation solubility was obtained from the Henry's law in this case. In the Henry's law, where dilute solution including a volatile solute is in equilibrium with a gas phase, partial pressure (p) of the solute in the gas phase is proportional to concentrations in the solution (mol fraction, x). Accordingly, the following formula (1) is formed.

p=Hx (1)

In the formula, H is the Henry's constant. This formula was transformed to obtain the value of x and thereafter the value of x was converted into the mg/L unit to calculate the saturation solubility.

For the value of H, an approximate value obtained by the Roth & Sullivan formula indicated by the formula (2) was used,

H=3.842×10⁷[OH]^{0.03 exp(2428/T)} (2)

In the formula, [OH⁻] is a concentration of hydroxide ion and T is a liquid temperature.

Removal of a photoresist with ozone water has not been popularized, since it is required to use a cleaning apparatus with a specific structure, and it is thus impossible to obtain a sufficient removal rate using a general-purpose cleaning apparatus.

A practical removal rate herein is 0.2 μm/min or more in a batch treatment system by means of immersion or the like, and 1.0 μm/min or more in a single wafer processing system by means of spraying from a nozzle or the like.

In the invention, supersaturated ozone water is used to remove a photoresist so that a sufficient removal rate is realized using a general-purpose cleaning apparatus.

In removal of a photoresist with ozone water, a removal rate is proportional to the dissolved ozone concentration of ozone water. Moreover, not only the ozone concentration but also an ozone water temperature affects the removal rate, so that a higher water temperature increases the removal rate. For example, provided that removal by decomposition reaction of photoresist conforms to the Arrhenius law, a rate constant (k) in decomposition reaction of photoresist increases exponentially due to increase in temperature, as shown in the following formula (3)

k=A exp(−E/RT) (3)

In the formula, A is a frequency factor, E is an activation energy, R is a gas constant, and T is a temperature.

However, in order to dissolve molecules in a gas state at normal temperature and normal pressure like ozone water in water, a high temperature is more disadvantageous than a low temperature as clarified from the formula (1) and the formula (2). That is, the saturation solubility is reduced at high water temperature so that it is difficult to be highly concentrated at a high temperature in the normal ozone water.

Thus, in the invention, highly-concentrated ozone water is allowed to be used even at a high temperature in the case of having a supersaturated state with solubility exceeding the saturation solubility, thus having both characteristics of a high temperature and a high concentration for increasing a removal rate.

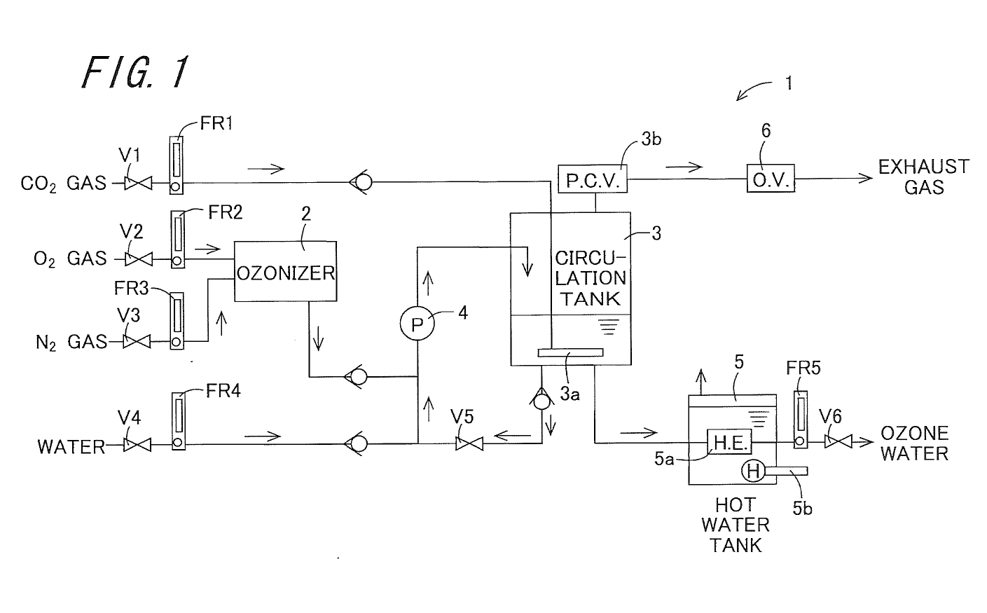

FIG. 1 is a schematic view showing a configuration of an ozone water production apparatus 1 for producing supersaturated ozone water. The ozone water production apparatus 1 includes an ozonizer (ozone producing device) 2, a circulation tank 3, a circulation pump 4, and a hot water tank for heat exchange 5, and further includes introducing pipes from respective supply sources of CO₂ (carbon dioxide) gas, O₂ (oxygen) gas, N₂ (nitrogen) gas, and water, valves provided in each of the pipes, flow meters, and the like.

The ozone water production apparatus 1 mixes ozone gas and water using the circulation pump 4, without being provided with a mixer, to dissolve ozone in water.

CO₂ gas is introduced to a bubbler 3a of the circulation tank 3 and supplied to ozone water stored in the circulation tank 3. By supplying CO₂ gas to ozone water, a pH of ozone water is adjusted to a desired pH. The pH of ozone water is almost 4 to 6, even though an optimum value thereof varies depending on use purpose of ozone water or the like.

In a supply amount of CO₂ gas, a flow rate is adjusted by opening and closing of a valve V1 provided between the supply source and the bubbler 3a, and a flow meter FR1. For supply of CO₂ gas, for example, supply pressure is 0.31 to 0.40 MPa and a flow rate is 100 to 1000 mL·min⁻¹.

O₂ gas and N₂ gas are introduced to the ozonizer 2, and the ozonizer 2 generates ozone. The generated ozone is mixed with supplied water and then introduced to the circulation pump 4. A pipe from the ozonizer 2 is connected to a water pipe to the circulation pump 4 using a T-shaped union joint to mix water and the generated ozone gas.

In a supply amount of O₂ gas, a flow rate is adjusted by opening and closing of a valve V2 provided between the supply source and the ozonizer 2 and a flow meter FR2, and in a supply amount of N₂ gas, a flow rate is adjusted by opening and closing of a valve V3 provided between the supply source and the ozonizer 2 and a flow meter FR3. For supply of O₂ gas, for example, supply pressure is 0.31 to 0.40 MPa and a flow rate is 1 to 10 L·min⁻¹. For supply of N₂ gas, for example, supply pressure is 0.31 to 0.40 MPa and a flow rate is 10 to 100 mL·min⁻¹.

In a supply amount of water, a flow rate is adjusted by opening and closing of a valve V4 provided between the supply source and the circulation pump 4, and a flow meter FR4.

Water and ozone gas that have been mixed in advance are further mixed inside the circulation pump 4 to dissolve ozone gas in water. Ozone water is discharged to the circulation tank 3 by the circulation pump 4 and mixed with CO₂ gas as described above.

In this case, the circulation pump 4 also needs to have a mixing function, and thus, it is preferable that a positive-displacement pump such as a bellows pump or a diaphragm pump is used. When a volute pump or the like is used as the circulation pump 4, a speed of pressure fluctuation of water is high and ozone molecules are decomposed into oxygen by mechanical energy. In addition, when the amount of ozone gas to be supplied is increased, it is impossible to normally perform liquid feeding, which is not preferable. Considering a mixing function, the circulation pump 4 preferably has a capability of about 0.5 to 5 L/cycle as discharge amount.

A part of the ozone water stored in the circulation tank 3 is returned to the water pipe to be mixed with the generated ozone gas, and thereafter introduced to the circulation pump 4. Ozone water is discharged from the circulation tank 3, and mixed with new water and ozone gas to be introduced to the circulation pump 4, so as to be circulated in a circulation line returning to the circulation tank 3. A discharge amount from the circulation tank 3 is adjusted by opening and closing of a valve VS provided between the circulation tank 3 and a connecting portion to the water pipe.

The circulation tank 3 is configured to store 2 to 20 L (liters) of ozone water at all times, in which it is preferable that the amount of circulation liquid is four times or more a discharge flow rate (use amount) of 1 to 10 L·min⁻¹ from the circulation tank 3, that is, 4 to 40 L·min⁻¹ or more.

The ozone water discharged from the circulation tank 3 is introduced to a heat exchanger 5a provided inside the hot water tank 5 and heated to a predetermined temperature. Hot water is stored as a heat exchange medium in the hot water tank 5 and heated to an appropriate temperature by a heater 5b.

In direct heating of ozone water by a sheathed heater or the like, large heat energy is locally applied and the excess heat energy decomposes ozone molecules in the ozone water into oxygen, and therefore heating by a heat exchanger is preferable. The heat exchanger 5a is preferably a heat transfer tube, for example, one using PFA or titanium. PFA is a copolymer of tetrafluoroethylene (TFE) and perfluoroalkoxy ethylene.

The ozone water heated to a predetermined temperature by the heat exchanger 5a is supplied to a cleaning apparatus and the like in subsequent stages.

A volume of the circulation tank 3 is 5 to 50 L, and the pressure in the circulation tank is adjusted with a pressure control valve 3b to, for example, 0.30 to 0.39 MPa.

In addition, the circulation tank 3 is also installed for gas-liquid separation in ozone water. Excess ozone gas that is not dissolved in ozone water is subjected to gas-liquid separation from solution in the circulation tank 3. Not only the excess ozone gas but also oxygen gas into which ozone gas is self-decomposed with time are then discharged via the pressure control valve 3b described above. Note that, ozone gas in exhaust gas is decomposed by an ozone decomposer 6 before being discharged to the atmosphere.

In a case where supersaturated ozone water is produced by the ozone water production apparatus 1 as described above, highly-concentrated ozone water of 300 mg/L or more is able to be realized even at high water temperature of 70° C. Note that, based on ozone water generation conditions of the ozone water production apparatus 1, saturation solubility of ozone at a water temperature of 70° C. obtained from the formula (1) and the formula (2) is 149 mg/L, and the ozone water at the concentration of 300 mg/L or more is supersaturated ozone water in a supersaturated state.

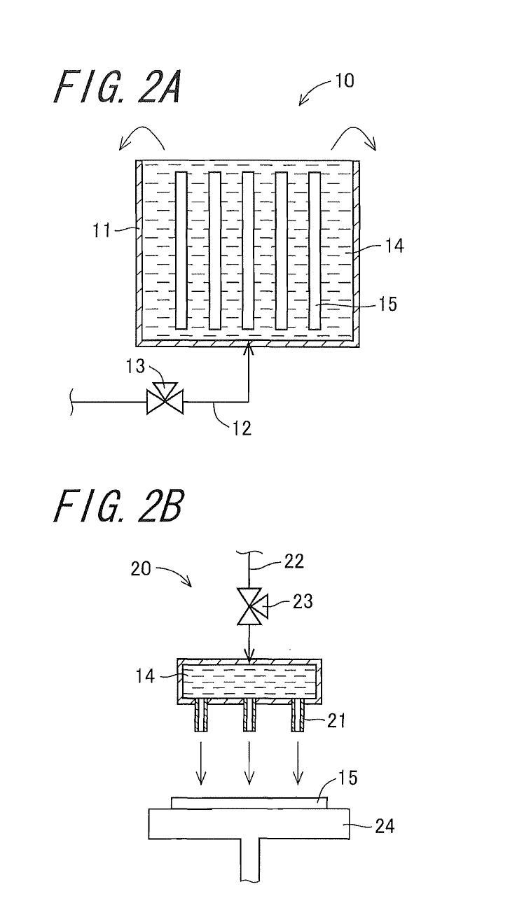

FIGS. 2A and 2B are views showing examples of general-purpose cleaning apparatuses. FIG. 2A is a schematic view of a batch treatment cleaning apparatus 10 for immersing a substrate on which a photoresist is formed in supersaturated ozone water 14 to remove the photoresist, and FIG. 2B is a schematic view of a single wafer processing cleaning apparatus 20 for discharging the supersaturated ozone water 14 from a nozzle to be sprayed to a substrate on which a photoresist is formed for removing the photoresist.

The batch treatment cleaning apparatus 10 includes a dipping vat 11 which is configured to be opened to the atmosphere and store the supersaturated ozone water 14, a supersaturated ozone water charging line 12 configured to supply the supersaturated ozone water 14 from the bottom of the dipping vat 11, and a needle valve 13 configured to adjust a flow rate of the supersaturated ozone water 14 that flows in the supersaturated ozone water charging line 12. To the supersaturated ozone water charging line 12, the ozone water production apparatus 1 is connected to supply the supersaturated ozone water 14 produced in the ozone water production apparatus 1 to the dipping vat 11.

The single wafer processing cleaning apparatus 20 includes a nozzle 21 configured to discharge the supersaturated ozone water 14 to be sprayed to a photoresist, a supersaturated ozone water charging line 22 configured to supply the supersaturated ozone water 14 to the nozzle 21, a needle valve 23 configured to adjust a flow rate of the supersaturated ozone water 14 that flows in the supersaturated ozone water charging line 22, and a platen 24 which places a silicon wafer 15 having a photoresist formed on a surface thereof facing the nozzle 21. To the supersaturated ozone water charging line 22, the ozone water production apparatus 1 is connected to supply the supersaturated ozone water 14 produced in the ozone water production apparatus 1 to the nozzle 21.

The batch treatment cleaning apparatus 10 and the single wafer processing cleaning apparatus 20 are general-purpose cleaning apparatuses, and the supersaturated ozone water 14 is applied as ozone water that is used in these cleaning apparatuses.

In the batch treatment cleaning apparatus 10, the supersaturated ozone water 14 is stored in the dipping vat 11 for immersing a plurality of the silicon wafers 15 having the photoresist formed on the surface thereof. The silicon wafers 15 are extracted after immersed for a predetermined time, thereby removing the photoresist.

In the single wafer processing cleaning apparatus 20, the supersaturated ozone water 14 is discharged from the nozzle 21, and the supersaturated ozone water 14 is sprayed to the photoresist formed on the surface of the silicon wafer 15, thereby removing the photoresist.

Even in a general-purpose cleaning apparatus, it is possible to realize a removal rate unfeasible with normal ozone water by using supersaturated ozone water.

Additionally, it is possible to further increase a removal rate by cleaning under a condition of suppressing reduction in ozone concentration in supersaturated water solution.

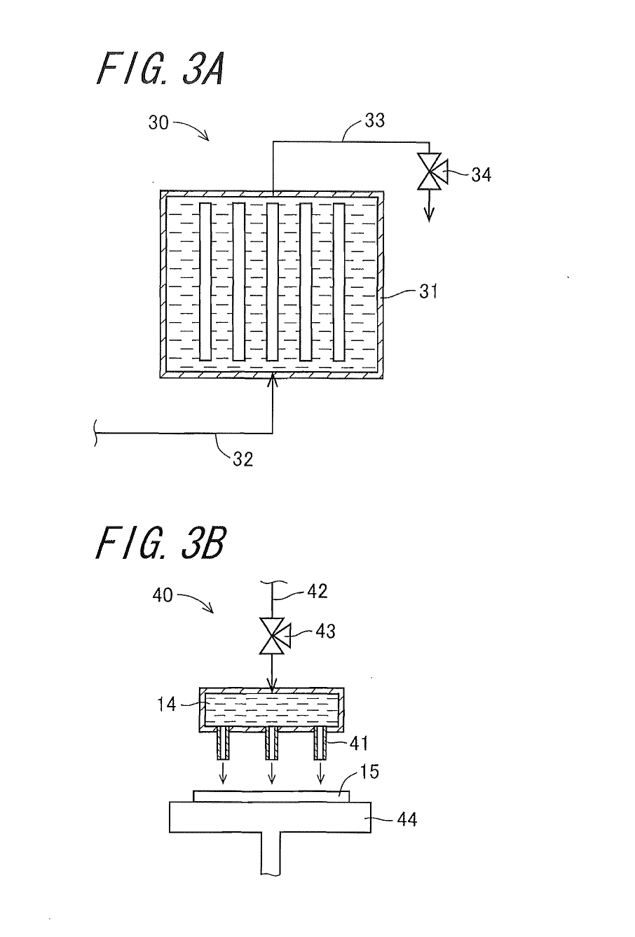

FIGS. 3A and 3B are views showing examples of cleaning apparatuses each including a function to suppress reduction in ozone concentration. FIG. 3A is a schematic view of a batch treatment cleaning apparatus 30, and FIG. 3B is a schematic view of a single wafer processing cleaning apparatus 40.

The batch treatment cleaning apparatus 30 includes a dipping vat 31 which is configured to be sealable and store the supersaturated ozone water 14, a supersaturated ozone water charging line 32 configured to supply the supersaturated ozone water 14 from the bottom of the dipping vat 31, a drain pipe 33 configured to discharge the supersaturated ozone water 14 from the dipping vat 31, and a needle valve 34 configured to adjust a flow rate of the supersaturated ozone water 14 that flows in the drain pipe 33. To the supersaturated ozone water charging line 32, the ozone water production apparatus 1 is connected to supply the supersaturated ozone water 14 produced in the ozone water production apparatus 1 to the dipping vat 31.

The dipping vat 31 is sealed in a state of immersing a plurality of silicon wafers 15 to adjust a flow rate of the supersaturated ozone water 14 that flows in the drain pipe 33, thereby keeping the pressure in the dipping vat 31 higher than atmospheric pressure. This makes it possible to suppress reduction in ozone concentration of the supersaturated ozone water 14 for immersion.

The single wafer processing cleaning apparatus 40 includes a nozzle 41 configured to discharge the supersaturated ozone water 14 to be sprayed to a photoresist, a supersaturated ozone water charging line 42 configured to supply the supersaturated ozone water 14 to the nozzle 41, a needle valve 43 configured to adjust a flow rate of the supersaturated ozone water 14 that flows in the supersaturated ozone water charging line 42, and a platen 44 configured to place the silicon wafer 15 having a photoresist formed on a surface thereof facing the nozzle 41. To the supersaturated ozone water charging line 42, the ozone water production apparatus 1 is connected to supply the supersaturated ozone water 14 produced in the ozone water production apparatus 1 to the nozzle 41.

In the general-purpose single wafer processing cleaning apparatus 20, the platen 24 is installed so as to have a distance of about 10 mm between a tip of the nozzle 21 and the silicon wafer 15. On the other hand, in the single wafer processing cleaning apparatus 40, the platen 44 is installed so as to have a distance of about 1 mm between a tip of the nozzle 41 and the silicon wafer 15. Thereby, the nozzle 41 is brought close to a photoresist so that it is possible to perform spraying to the photoresist under a condition where a pressure applied on supersaturated water solution is higher than atmospheric pressure.

As described above, reduction in ozone concentration of supersaturated ozone water is suppressed so that it is possible to further increase a removal rate of photoresist.

### EXPERIMENTAL EXAMPLE 1

In Experimental Example 1, in order to compare a removal rate of photoresist between normal ozone water and supersaturated ozone water, the batch treatment cleaning apparatus 10 and the single wafer processing cleaning apparatus 20 shown in FIGS. 2A and 2B were used to remove a photoresist.

In this example, the normal ozone water at the temperature of 50° C. and the concentration of 50 mg/L shown in Patent Literature 1 was used. On the other hand, the supersaturated ozone water at the temperature of 70° C. and the concentration of 300 mg/L from the ozone water production apparatus 1 was used.

A test sample used in the experiment has a positive-type resin with thickness of 2 μm in which a phenolic novolac resin serves as a base polymer was applied on a silicon substrate, followed by baking. Note that, the sample in the experiment had no circuit pattern, and an entire surface of the silicon substrate was covered with resist.

Measurement results of removal rates of photoresist using this sample are shown in Table 1.

TABLE 1

Removal rate (μm/min)

| | Normal ozone | Supersaturated |
|---|---|---|
| | water | ozone water |
| Batch treatment | 0.06 | 0.29 |
| system | | |
| Single wafer | 0.67 | 2.18 |
| processing system | | |

In a batch treatment system, a removal rate in the case of using the supersaturated ozone water was indicated as 0.29 μm/min, and the rate was about five times higher than that in the case of using the normal ozone water. Further, the rate reached a rate of 0.2 μm/min or more as a standard of practical application.

Moreover, in a single wafer processing system, a removal rate in the case of using the supersaturated ozone water was indicated as 2.18 μm/min, and the rate was also about three times higher than that in the case of using the normal ozone water. Further, the rate also reached a rate of 1.0 μm/min or more as a standard of practical application.

Therefore, these results allowed to confirm high effectiveness in a method for removing a photoresist using the supersaturated ozone water.

### EXPERIMENTAL EXAMPLE 2

An object of the invention is to reduce an economic burden in switching from a conventional cleaning in order to widely popularize ozone water cleaning with a reduced environmental load. However, in the case of preceding increase of a removal rate of photoresist rather than reduction of an economic burden, it is preferable to use the batch treatment cleaning apparatus 30 and the single wafer processing cleaning apparatus 40 each provided with a mechanism for suppressing reduction in ozone concentration as shown in FIGS. 3A and 3B,

Supersaturated ozone water (temperature: 70° C.; concentration: 300 mg/L) was used in the batch treatment cleaning apparatus 30 and the single wafer processing cleaning apparatus 40 to remove a photoresist, and removal rates were measured as with Experimental Example 1. The results are shown in Table 2.

TABLE 2

| | Removal rate (μm/min) |
|---|---|
| Batch treatment system | 1.33 |
| Single wafer processing system | 2.40 |

In the case of the improved batch treatment system, a removal rate was indicated as 1.33 μm/min, showing a rate about five times higher than that in the case of using a general-purpose cleaning apparatus. On the other hand, a removal rate in the improved single wafer processing system was also increased to 2.40 μm/min.

Therefore, these results also allowed to confirm high effectiveness of the method for removing a photoresist using the supersaturated ozone water.

The invention is not limited to the above-described respective embodiments, and various changes, modifications and the like can be made thereto without departing from the scope of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: Ozone water production apparatus

2: Ozonizer

3: Circulation tank

3a: Bubbler

3b Pressure control valve

4: Circulation pump

5: Hot water tank for heat exchange

5a: Heat exchanger

5b Heater

6: Ozone decomposer

10, 30: Batch treatment cleaning apparatus

11, 31: Dipping vat

12, 32: Supersaturated ozone water charging line

13, 34: Needle valve

14: Supersaturated ozone water

15: Silicon wafer

20, 40: Single wafer processing cleaning apparatus

21, 41: Nozzle

22, 42: Supersaturated ozone water charging line

23, 43: Needle valve

24, 44: Platen

33: Drain pipe

1. A method for removing a photoresist, comprising:
performing a removal operation of removing a photoresist formed on a surface of a substrate using supersaturated water solution of ozone.

2. The method of claim 1, wherein the removal operation is performed under a condition of suppressing reduction in ozone concentration of the supersaturated water solution,

3. The method of claim 2, wherein the removal operation is an operation for immersing the substrate on which a photoresist is formed in a dipping vat storing the supersaturated water solution, and
the dipping vat is composed of an airtight container in which the substrate is immersed under a condition where a pressure in the airtight container is higher than atmospheric pressure.

4. The method of claim 2, wherein the removal operation is an operation for discharging the supersaturated water solution from a nozzle to spray the supersaturated water solution to the photoresist formed on the surface of the substrate, and
the nozzle is brought close to the photoresist to perform spraying to the photoresist under a condition where a pressure applied on the supersaturated water solution is higher than atmospheric pressure.
